(19) United States
(12) Patent Application Publication
(10) Pub. No.: US 2013/0131364 A1
(43) Pub. Date: May 23, 2013

(54) SEPARATING BIOMASS FROM AN AQUEOUS MEDIUM

(71) Applicant: Hendrik Arie Boele, Rijkevorsel (BE)

(72) Inventor: Hendrik Arie Boele, Rijkevorsel (BE)

(73) Assignee: EVODOS ALGAE TECHNOLOGIES B.V., Breda (NL)

(21) Appl. No.: 13/639,443

(22) PCT Filed: Jun. 7, 2011
(86) PCT No.: PCT/NL2011/050406

§ 371 Date: Jan. 27, 2013

(30) Foreign Application Priority Data
Jun. 7, 2010 (NL) 2004832

(51) Int. Cl. C11B 1/00

(52) U.S. Cl. CPC C11B 1/00
USPC 554/175; 422/255; 554/1

(57) ABSTRACT

Method for isolating biomass from an aqueous medium comprising cellular material comprising the steps of: 1) providing an aqueous medium comprising cellular materialalgae; followed by 2) subjecting the cellular materialalgae in said aqueous medium to lysis, whereby a lipid fraction comprising algal lipids and a solids fraction comprising algal solid material are formed, which fractions are dispersed in said aqueous medium; 3) separating at least part of said lipid fraction from the aqueous medium; 4) separating at least part of said solids fraction from the aqueous medium; wherein steps 3) and 4), and preferably also step 2), are performed in a single apparatus. The method is particularly suitable for isolating lipids from algae.

The invention relates to a method for isolating cellular material, in particular cellular material originating from algal biomass from an aqueous medium, to an apparatus for isolating such biomass from an aqueous medium and to such biomass, in particular algal biomass obtainable via said method and/or said apparatus. Although the present invention makes specific reference to algae, it is to be understood that it may also be employed in lysing (viz. breaking up) other cellular (organic) material, such as orange peels, palm oil hulls, yeast, and the like.

The depletion of the Earth's fossil fuel supplies leads to an increasing demand for alternative sources of energy. Besides, there is a desire for alternative fuels that do not contribute to the greenhouse effect via a net release of carbon dioxide into the atmosphere (carbon neutrality). An important alternative source of energy is biofuel, which is a fuel derived from biological material that has been lifeless for a relatively short period of time, for example a period of up to a year. Accordingly, the amount of carbon that is released during the combustion of biofuels can be considered to be balanced by the amount of carbon that has previously been sequestered in the biological material from which the biofuel has been isolated.

One class of organisms that is considered suitable for the mass-production of biofuel are algae, as the biomass of certain algal species contains high amounts of oil and carbohydrates; algal oil can be converted into biodiesel and the algal carbohydrates can be fermented into bioethanol and biobutanol. Algal fuel is considered to be a third-generation biofuel (first-generation biofuels are derived from food components, such as sugar, starch, vegetable oil, or animal fats using conventional technology; second generation biofuel is based on the residual of t non-food parts of current crops).

An advantage of the cultivation of algae (algaculture) is that algae have a fast growth rate, can be cultivated in ocean water and wastewater, and are relatively harmless to the environment if spilled. In addition, algae may be cultivated on (inundated) land that is not suitable for other established crops, which avoids competition with production of foods.

To date, however, the production of biofuel from algae (algal fuel) cannot yet compete with the production of other fuels, in particular fossil fuels.

An important reason for this is that the isolation of algal biomass from its harvested growth medium has been found to be complex and energy intensive. As the algal content in the harvested growth medium is generally lower than 1 wt %, large amounts of water need to be removed in order to obtain the desired concentration of algal products.

In the art, algal constituents are usually isolated by concentrating the harvested growth medium containing the algae, followed by lysing (disrupting) the algae and separating the resulting mixture into the desired constituents, usually a lipid fraction, an aqueous fraction and a solid fraction. The lysing (disrupting) of the algae is carried out for instance by using enzymes, by increasing the turgor in the cells above the critical value by adding certain compounds to the slurry, by applying electroshocks or pH changes, or simply by running the slurry through a press. Usually common centrifuges are used for separating the resulting mixture into a lipid stream and an aqueous stream. The high energy intensity and the low selectivity of separation processes used in the art are also responsible for the fact that the production of algal fuels can up to date not compete with the production of other fuels.

It is an object of the invention to provide a method for isolating cellular material, in particular cellular material originating from algal biomass from an aqueous medium, in particular a method that requires less energy than methods known in the art.

It is a further object of the invention to provide a method for isolating cellular material, in particular cellular material originating from algal biomass from an aqueous medium, which method has less process steps than methods known in the art

It is a further object of the invention to provide an apparatus for isolating cellular material, in particular cellular material originating from algal biomass from an aqueous medium, in particular an apparatus that is energy efficient and/or has a high selectivity.

It has now been found possible to provide a method for isolating cellular material, in particular cellular material originating from algal biomass from an aqueous medium, that is particularly energy efficient and separates the components of cellular material, such as algal biomass in high selectivity. Such method has been obtained by performing a plurality of process steps in a single single mechanical apparatus.

Accordingly, the present invention relates to a method for isolating cellular material, in particular cellular material originating from algal biomass from an aqueous medium comprising cellular material, in particular algae, comprising the steps of:

1) providing an aqueous medium comprising cellular material, in particular algae; thereafter

2) subjecting the cellular material, in particular algae in said aqueous medium to lysis, whereby a first fraction (for algae a lipid fraction comprising lipids and enclosed water) and a solids fraction comprising solid material are formed, which fractions are dispersed in said aqueous medium;

3) separating at least part of said first fraction from the aqueous medium;

4) separating at least part of said solids fraction from the aqueous medium;

wherein steps 3) and 4), and preferably also step 2), are performed in a single apparatus.

The term “biomass” as used herein, refers to material of biological origin, in particular material that comprises cells having a cell wall and cell contents, wherein the cell contents comprises the compounds of interest, viz. the compounds to be purified.

It has been found that, with a method of the invention, the energy that is required to obtain biofuel from algae in a growth medium can be as low as 2.2 MJ/kg. It is estimated that in processes used in the art, this value is considerably higher, sometimes as high as 25 MJ/kg or even more. Bearing in mind that the energy content of commercial algae products is around 20 MJ/kg (on a dry matter basis), it follows that the present invention enables commercial exploitation of algae as biomass in providing a separation step that is crucially low in energy consumption.

The aqueous medium comprising cellular material may be a substantially unprocessed harvested growth medium containing the cellular material. Thus the present invention does not require extensive preprocessing of the harvested stream.

Cellular material that is very suitable for being used in the present invention is algae. It is estimated that around a hundred thousand different species of algae exist. Algae that may be used in a method of the invention are microalgae and/or macroalgae.

Preferably, the algae used in a method of the invention are microalgae.

Microalgae (also referred to as phytoplankton or microphytes) are unicellular species which exist individually, in chains or in groups. Depending on the species, their sizes can range from about 2 μm to about 500 μm. Examples of microalgae are diatoms and cyanobacteria.

Microalgae that are particularly preferred are Botryococcus braunii, Chlorella, Dunaliella tertiolecta, Gracilaria, Pleurochrysis carterae (also called CCMP647), or Sargassum.

Macroalgae, commonly known as seaweed, are multicellular marine algae. Due to their size and the specific requirements of the environment wherein they grow, they do not lend themselves as readily to cultivation as microalgae. In case macroalgae are used, it is preferred to fragment the macroalgae into pieces of a uniform size, for example into pieces having their dimensions in the range of 10 μm-10 mm, before the lysation step.

With “lysing” of the algae or “subjecting the algae to lysis” is meant that the cells of the algae (algal cells) or other origin are destroyed by disrupting the cell walls and cell membranes, thereby releasing the contents present within the cell. Preferably, all cells, or substantially all cells (preferably more than 99 wt. %) are lysed in the lysing step.

The steps of separating the first fraction (e.g. the lipid fraction) and the solids fraction from the aqueous fraction is preferably carried out in a rotational separator having a rotatable inner element which supports one or more curved plates, which are flexibly connected to said inner element and a rotatable outer element which is coaxially arranged around the inner element, wherein both elements are rotatable around their centre axis, and wherein the one or more plates are supported by the outer element, further comprising feeding means at one end of the separator for supplying a feed stream to be separated and discharging means at an opposite end of the separator for discharging separated streams, wherein between adjacent curved plates and the first and second element confined spaces are defined for separation of the feed stream under influence of centrifugal forces, wherein the outer carrier is axially removable from the second carrier for removing components collected on the plates. This type of separator is commercially available under the trade name Evodos™ and is described in detail in WO-A-2009/05355, which is incorporated herein by reference.

In operation, the Evodos™ separator the first and second element rotate at similar angular speed, so that they do not or not substantially move relative to each other. As a result of the curved shape of the plates, the particles (e.g. lipid particles from the lipid fraction when algae slurries are processed and solid particles from the solid fraction) impinge with the plates, after having travelled only a very short distance. Because this travelled distance is so small, the Evodos™ separator is a very efficient separator. Typically the separator rotates at around 2000-5000 rpm, preferably from 4000-4500 rpm. The rotational speed can be selected such that the desired level of artificial gravity is obtained. Artificial gravity is dependent on both rotational speed and rotor diameter. Evodos works usually at approximately 2000-4000×G, for instance at about 3000×G.

During the rotating action the first fraction (e.g. lipid fraction) and the aqueous fraction will, due to their difference in density, separate under the influence of the centrifugal force and exit the separator as essentially separate streams of a lipid rich stream (for algae) and a water rich stream. The solids accumulate on the plates. After some time, the solids can be discharged by stopping the rotating action and removing the outer element, usually by slidingly removing it in the direction of the axis. When the outer element is removed, the inner element is rotated so that the solids will be ejected therefrom after which they can be collected. Once the plates are cleaned in this way, the device can be reassembled by sliding the outer element back in its place.

For continuous operation two or more of these devices can be used in parallel.

Preferably, the 2), 3) and 4) are all carried out in the same apparatus, in particular in a rotational separator described above. The step of subjecting the cells, such as the algae in the aqueous medium to lysis can be carried out in various ways. It is possible to use one or more of the prior art methods referred to above (viz. by adding one ore more enzymes, by increasing the turgor in the cells above the critical value by adding certain compounds to the slurry, by applying electroshocks or pH changes, or simply by running the slurry through a press).

The invention further relates to an apparatus for isolating cell content from cellular material comprised in an aqueous medium, wherein the apparatus comprises a centrifugal separator, further comprising a lysis device arranged upstream of the centrifugal separator in an aqueous medium supply stream for lysing the cellular material.

By providing a lysing device for first lysing the cellular material such that the cell contents are freed before entering the centrifugal separator, the medium in the separator can be separated in different fractions, such as a solid fraction containing the cell content and a liquid fraction. Depending on the type of centrifugal separator used, more fractions may be obtained, e.g. a solid fraction, a lipid fraction and an aqueous fraction. By first lysing the cellular material and thereafter supplying the lysed material in the aqueous supply stream to the centrifugal separator, the cell contents of the lysed material can be relatively efficiently and effectively be separated from the supply stream.

Preferably, the lysis device is arranged to induce a collision of the aqueous medium supply stream with a rough surface on the lysis device. By providing a rough surface on the lysis device and by arranging that the cellular material of the aqueous medium collides with the rough surface, the cells are broken and the cell contents can be freed.

In one embodiment, the feed is allowed to enter the rotational type separator through a central tube and exits near the bottom of the separator. Then the feed stream is subjected to high shear stresses, e.g. by jetting, optionally while contacting it with a rough surface.

The invention will further be elucidated on the basis of an exemplary embodiment which is represented in a drawing. The exemplary embodiment is given by way of non-limitative illustration of the invention.

In the drawing:

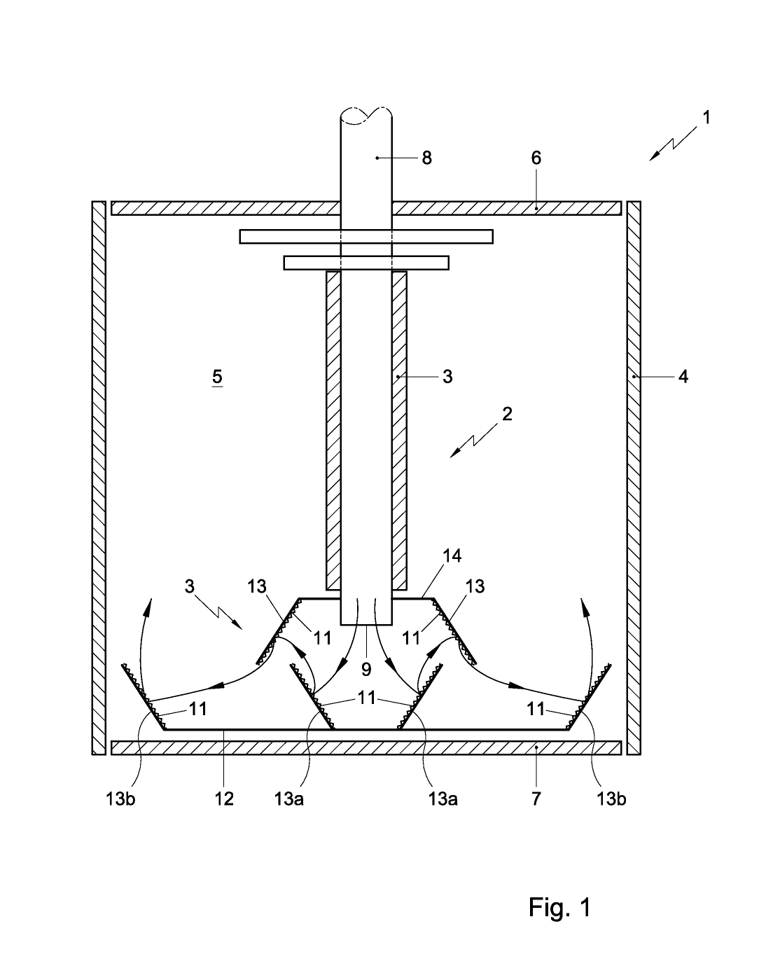

FIG. 1 shows a schematic cross sectional view of an embodiment of the apparatus according to the invention.

It is noted that the figure is only a schematic representation of an embodiment of the invention that is given by way of a non-limiting example. In the figure, the same or corresponding parts are designated with the same reference numerals.

FIG. 1 shows an apparatus 1 comprising a centrifugal separator 2 and a lysis device 3. The centrifugal separator 2 is in this embodiment a plate type centrifugal separator. Such type of centrifugal separator is commercially available under the Evodos™ trademark. Of course, other types of centrifugal separators may be used and the invention is not limited to the use of the described type of separator.

The centrifugal separator 2 comprises an upwardly extending first element 3 and an upwardly extending second element 4. The first element 3 and the second element 4 are approximately concentrically arranged such that the first element 3 is the inner element 3 and the second element 4 is an outer element 4. Both the inner element 3 and the outer element 4 are rotatable arranged. During use the inner element 3 and the outer element 4 rotate with the same rotational speed. Between the inner element 3 and the outer element 4 an inner space 5 is provided in which the separation takes place under influence of centrifugal force during rotation.

The inner element 3 is provided with elongate elements, such as vanes or blades or plates. The elongate elements are not shown in FIG. 1. During rotation the inner element 3 and the outer element 4 are mechanically coupled via the elongate elements. The elongate elements can be flexible or stiff, curved or straight, rigidly coupled to the inner element or hingedly coupled to the inner element. Many variants are possible. It may be clear that in other embodiments the outer element may be provided as the first element with vanes connected thereto and the inner element may be provided as the second element.

The inner element 3 is during use rotated, the elongate elements rotate with the same rotational speed. Due to the mechanical coupling of the outer element 4 with the inner element 3 via the elongate elements, the outer element 4 rotates with the same rotational speed as the inner element 3. A mechanical coupling between the inner element 3 and the outer element 4 during rotation can also be provided otherwise, e.g. the inner element 3 and the outer element 4 can be driven by a same drive unit or can be driven by different drive units which may be synchronized or may be mechanically coupled by spacer elements such as rods, the coupling of which may be undone upon termination of the rotation allowing the outer element 4 to be removed with respect to the inner element 3.

The inner element 3 is in this embodiment carried out as a hollow shaft, but can have different cross-sections such as e.g. triangular or rectangular or oval. The outer element 4 is in this embodiment provided as a cylindrical sleeve surrounding the inner element 3, but can also have different cross-sections, such as e.g. triangular or rectangular or oval.

The centrifugal separator 2 can be used for separating one or more components from an aqueous medium e.g. separating solid particles dispersed in a liquid from the liquid, or solid particles solved in a liquid. Also, liquids of different densities may be separated, e.g. lipid from water. From the apparatus 1 the solid particles can be collected and the liquid can be collected. A centrifugal separator can be used for separating various types of aqueous solutions, e.g. algae dispersed in water, soft solids dispersed in oil, water dispersed in oil.

Separation of particles from a medium in which they are comprised is based on the difference in specific gravity of the particles and the medium. By rotation of the first element 3 with vanes an artificial field of gravity is created due to the centrifugal force. Particles with different specific gravities are thus separated.

The apparatus 1 is closed at an upper end with an upper closing end piece 6 and a lower end with a lower closing end piece 7. The upper and the lower closing end pieces 6, 7 are in this embodiment mounted on the first element 3. The outer element 4 is in this embodiment removable arranged with respect to the inner element 3. After centrifuging, the rotation can be stopped and the outer element 4 can be removed from the inner element 3. The rotation of the inner element 3 is started again and, in particular when the vanes are flexible or hingedly connected to the inner element 3, the vanes spread out and separated particles clogged to the vanes can be removed due to the centrifugal force.

Through the hollow rotational shaft 3 a feed line 8 is provided through which the aqueous medium can be fed to the centrifugal separator 2. At a lower end of the feed line 8, an outflow opening 9 is provided via which the aqueous medium can be supplied. Between the outflow opening 9 and the centrifugal separator 2, a lysis device 10 is arranged.

For isolating the cell content from cellular material, the cell has to be damaged to free the cell content. Since the cellular material usually is supplied in an aqueous solution, the cell content then, once free, also becomes part of the aqueous solution. By providing the aqueous solution to a centrifugal separator, different fractions of the aqueous solution may be separated, e.g. a cell content fraction and a liquid fraction. Many other fractions may be possible, such as a solid fraction and/or a lipid fraction. An example can be an aqueous solution comprising algae. By lysis of the algae, the cell content of the algae, e.g. comprising algal lipids is freed from the algae. The aqueous solution with the algal solids and the algal lipids can be supplied to a centrifugal separator such that different fractions may be obtained: an algal solid fraction, an algal lipid fraction and a liquid (aqueous) fraction. An other example may be orange peels. Orange peels waste can be milled first and converted into a slurry, for instance by adding water. This slurry is then subjected to the process of the present invention and similar results are obtained.

By positioning the lysis device 10 upstream of the centrifugal separator 2, the aqueous medium with the lysed cellular material can be supplied to the centrifugal separator. In this embodiment, the lysis device 10 and the centrifugal separator 2 form a single apparatus 1. Alternatively, the lysis device may be provided as a separate apparatus placed in series with the centrifugal separator 2.

The lysis device 10 is arranged to induce collision of the aqueous medium supply stream supplied via the feed line 8 to the device 10 with a rough surface 11 provided on the device 10. The rough surface 11 is sufficiently rough to induce lysis of cellular material that becomes in contact with the rough surface 11. The rough surface 11 can e.g. be sintered or otherwise roughened. Typically surface roughness (as expressed by the profile roughness parameter, Rₐ) may range from several microns to several mm, e.g. 2 μm to 5 mm.

When the cellular material comprised in the aqueous solution comes in contact with the rough surface 11, the cells of the cellular material are damaged and the cell content can be freed. In this embodiment, the lysis device 10 comprises a rotatable holder 12 supporting upwardly arranged ribs 13 with a rough surface 11 on at least one side. The ribs 13 may for example be arranged as annular rings. Further, the lysis device 10 comprises a static holder 14 arranged oppositely the rotatable holder 12 supporting ribs 13 that extend towards the rotatable holder 12 in mounted condition. By providing a lysis device 10 thus configured, a flow path is created for the supply stream in which collision of the supply stream with the rough surfaces 11 is induced such that lysis of the cellular material of the supply stream is obtained.

In this embodiment is the rotatable holder provided with two annular rib rings 13, an inner ring 13a and an outer ring 13b. Many other configurations and more or less ribs may be possible. Here, the flow direction of the supply stream needs to be turned, so two annular rings of ribs 13 are provided to redirect the direction of the supply stream. When the lysis device is for example arranged as a separate apparatus in series with the centrifugal separator, a different arrangement of the ribs may be provided. Also, when the supply stream is supplied in line with the centrifugal separator, such that the flow direction is in line with the centrifugal separator, a different configuration of the ribs may be provided.

In this embodiment, the outflow opening of the feed line is located at a lower end of the centrifugal separator, but it can also be located at an upper end of the centrifugal separator. Also, the feed line may be connected directly to the centrifugal separator and may not have to run through the rotational shaft.

In one embodiment of the invention, the aqueous medium comprising the cellular material is fed to the rotational separator mentioned above using a high pressure (e.g. several bars to several hundreds of bars, typically 5-200 bar) pump. The pressure drop can be provided by a nozzle, which serves to spray the aqueous feed. This spraying action in itself results in high shear forces, thus already lysing at least some of the cellular material. Then the spray is impinged on the rotating roughened surface, resulting in further abrasive action giving rise to further lysis of the cells. An important advantage of this embodiment is that the kinetic energy of the liquid leaving the nozzle, may be partly converted into rotational energy of the roughened surface, thus regaining a substantial part of the energy used to compress the feed.

Many variants will be apparent to the person skilled in the art. For example, various arrangements of the lysis device may be possible. All variants are understood to be comprised within the scope of the invention as defined in the following claims.

1. Method for isolating cellular material, in particular cellular material originating from algal biomass, i.e. material of biological origin that comprises cells having a cell wall and cell contents, in particular algal biomass from an aqueous medium comprising cellular material, in particular algae, comprising the steps of:
1) providing said aqueous medium comprising cellular material; followed by
2) subjecting the cellular material in said aqueous medium to lysis, whereby a first fraction comprising liquids and a second fraction comprising solid material are formed, which fractions are dispersed in said aqueous medium;
3) separating at least part of said liquid fraction from the aqueous medium;
4) separating at least part of said solids fraction from the aqueous medium;
wherein steps 3) and 4), and also step 2), are performed in a single mechanical apparatus, which apparatus comprises a centrifugal separator and further comprises a lysis device arranged upstream of the centrifugal separator.

2. (canceled)

3. (canceled)

4. Method according to claim 1, wherein the aqueous medium is concentrated before lysing the cellular material.

5. Method according to claim 1, wherein the aqueous medium comprising cellular material is a substantially unprocessed harvested growth medium containing the cellular material.

6. Method according to claim 1, wherein said cellular materials are algae and wherein said first fraction comprises algal lipids.

7. Apparatus for isolating cell content from cellular material comprised in an aqueous medium comprising a centrifugal separator, further comprising a lysis device arranged upstream of the centrifugal separator in an aqueous medium supply stream for lysing the cellular material, wherein the centrifugal separator and the lysis device are arranged in a single mechanical apparatus.

8. Apparatus according to claim 7, wherein the lysis device is arranged to induce a collision of the aqueous medium supply stream with at least one rough surface of the lysis device.

9. Apparatus according to claim 8, wherein the lysis device comprises a rotatable holder supporting at least one rough surface.

10. Apparatus according to claim 8, wherein the lysis device comprises a static holder supporting at least one rough surface.

11. Apparatus according to claim 10, wherein the static holder is arranged opposite the rotatable holder to create a flow path for the aqueous medium supply stream such that collision with at least one rough surface is induced for lysing cellular material.

12. Apparatus according to claim 10, wherein the rotatable holder and/or the static holder support an upstanding rib comprising the rough surface.

13. Apparatus according to claim 9, wherein the rough surface comprises sintered material.

14. Apparatus according to claim 7 wherein the centrifugal separator comprises a rotatably arranged upwardly extending first element with elongate elements connected thereto and an upwardly extending second element, wherein the first element and the second element are approximately concentrically arranged with respect to each other resulting in an inner element and an outer element and wherein the elongate elements extend from the first element towards the second element.

15. Apparatus according to claim 7, wherein the apparatus comprises a supply opening arranged at an outer end of the separator for supplying the aqueous medium comprising the cellular material to be separated and further comprising a discharge opening arranged at an opposite outer end for discharging separated fractions.

16. Lysis device for use in an apparatus according to claim 7, wherein the lysis device is arranged to induce a collision of the aqueous medium supply stream with at least one rough surface of the lysis device.

17. (canceled)

18. Cellular material originating from algal biomass obtainable by a method according to claim 1.

19. Use of a rotational separator in the processing of an aqueous medium containing cellular material according to the method of claim 1.

20. Use of cellular material originating from algal biomass according to claim 18, for the preparation of medicines and/or biofuel.

21. Method according to claim 19 comprising a step wherein cellular material is fed to the rotational separator using a pressure of 5-200 bar.
